(19) United States
(12) Patent Application Publication
(10) Pub. No.: US 2019/0266560 A1
(43) Pub. Date: Aug. 29, 2019

(54) FACILITATING PARCEL DELIVERY TO A DRIVING APPARATUS

(71) Applicant: Wellen Sham, Taipei City (TW)

(72) Inventor: Wellen Sham, Taipei City (TW)

(21) Appl. No.: 15/903,623

(22) Filed: Feb. 23, 2018

(51) Int. Cl. G06Q 10/08

(52) U.S. Cl. CPC G06Q 10/0836

(57) ABSTRACT

Embodiments can facilitate parcel delivery to a driving apparatus. In one embodiment, for facilitating such, the driving apparatus can a secured component, a communication component, a circuit, a processor, and/or any other component. The secured component may be openable through a code and contents within the secured component can be accessed when it is open. The communication component can be configured to communicate with a remote device. The remote device may include a remote computer server, a computing device associated with a user of the driving apparatus, and/or any other remote device. The processor can be configured to receiving a delivery indication that a parcel is to be delivered to the driving apparatus and facilitate unlocking the secured component through the code associated with the secured component.

### BACKGROUND OF THE INVENTION

This invention relates generally to facilitating courier delivery services to a driving apparatus.

Parcel delivery is generally known in the art. Such delivery typically involves shipping containers, parcels, or high value mail as single shipments. Many delivery service providers such as postal systems, express mail, and private courier companies, provide such delivery. As e-ecommerce becomes popular among general public, many online stores also ship products ordered by customers through parcel delivery service either operated by themselves or by a delivery service provider. More recently, many traditional brick and motor retailers are also offering their customers to order products either in store or online and then later deliver the ordered products to them.

Traditionally, delivery service could be tedious when an intended recipient is not present at a location where the parcel is ordered to be delivered to. Typically repeated delivery has to be made until that recipient is present. In some situations, if the delivery has been attempted more than 3 times, the parcel may be returned to the sender without further attempts. This results in resource waste and time waste.

### BRIEF SUMMARY OF THE INVENTION

Various embodiments can facilitate parcel delivery to a driving apparatus such as a vehicle. As driving apparatus is mobile and typically is accessible to a delivery service, parcel delivery may be made to the driving apparatus with or without presence of an recipient. In some embodiments, a secured component can be installed or attached to driving apparatus so that the parcel can be delivered to the secured component when the recipient is not present in the driving apparatus. Another advantage of delivering a parcel to a driving apparatus is that the driving apparatus (as well as the recipient) may be on the move and thus at a location convenient for the delivery. For example, the recipient's house may be located at a fixed location far from a delivery service while the recipient's vehicle may be on the move close to the delivery service for receiving the parcel. Still another advantage of delivering to a driving apparatus is that many people will travel in a driving apparatus for at least once during the day. Thus delivering to the driving apparatus may enable the recipient to receive the parcel more reliably. Other advantages are contemplated.

In one embodiment, for facilitating parcel delivery to a driving apparatus, the driving apparatus in accordance with the disclosure includes a secured component, a communication component, a circuit, a processor, and/or any other components. In that embodiment, the secured component can have a cover member. The secured component may have a locked state, an unlocked state and/or any other state. In the unlocked state, the cover of the secured component can be opened so that one or more subjects stored within the secured component can be accessed. In various implementations, the secured component may be associated with a code that can be used to unlock the secured component into the unlocked state. Examples of such a code may include a passcode that can be entered by a person, a machine-readable instruction that can be execute to unlock the secured component, and any other code. In some implementations, the secured component may be a lockbox that can be installed on a body of the driving apparatus.

The communication component can be configured to communicate with a remote device. The remote device may include a remote computer server, a computing device associated with a user of the driving apparatus, and/or any other remote device. The communication component may include a transceiver component that can be configured to receive and transmit information wireless, such as via Bluetooth, Laser, infrared, WiFi, and/or any other wireless means.

The circuit may be configured to store various information regarding the secured component and/or the driving apparatus. For example, the circuit can be configured to store the code associated with the driving apparatus, an identification associated with the driving apparatus, a network ID associated with the driving apparatus, and/or any other information.

The processor can be configured to execute machine-readable instructions such that when the machine-readable instructions are executed, the processor is caused by the execution of the machine-readable instructions to perform one or more operations. The operations may involve receiving a delivery indication that a parcel is to be delivered to the driving apparatus. The operations may involve generating current location information indicating a current location of the driving apparatus. The operations may involve generating, for transmission to the remote device, a response including the current location information. The operations may involve receiving a request, from the remote device, for unlocking the secured component. The operations may involve retrieving the code associated with the secured component from the circuit. The operations may involve facilitate unlocking the secured component through the code associated with the secured component.

In some embodiments, the communication unit can be configured to communicate with the processor. For example, the communication unit can be configured to transmit an occupation indication to the processor indicating the secured component is occupied with a parcel; and transmit a removal indication to the processor indicating the secured component the parcel has been removed from the secured component.

In some embodiments, the processor can be further caused by the execution of the machine-readable instructions to perform: determining if the delivery indication is received, and determining if the occupation indication is received from secured component. When the occupation indication and the delivery indication are determined to have been both received, the processor can be configured to generate a confirmation indication for transmission to a computing device associated with a user of the driving apparatus. In one embodiment, the location information and the response are periodically generated until the occupation indication is received from the secured component. The code associated with the secured component can be further associated with a user of the driving apparatus.

In some embodiments, the delivery notification can include information indicating an intended recipient of the parcel. In those embodiments, the processor can be further caused by the machine-readable instructions to perform: receiving identification information regarding a user of the driving apparatus, the user being within the driving apparatus; and determining whether the user of the driving apparatus is the intended recipient of the parcel. When it is determined that the user is the intended recipient of the parcel, the processor can be configured to generate presence information indicating the intended recipient is within the driving apparatus; and, and the response transmitted to the remote device can further include the presence information.

In some embodiments, the processor can be further caused by the machine-readable instructions to perform: receiving, over a network, an unlock instruction to unlock the secured component; and, where. In some embodiments, the processor can be further caused by the machine-readable instructions to perform: implementing the unlocking instruction using the code. In some embodiments, where the processor is further caused by the machine-readable instructions to perform: transmitting, over a network, the code associated with secured component for unlocking the secured component. In some embodiments, the processor is further caused by the machine-readable instructions to perform: determining if the secured component is occupied. In some embodiments, the processor is further caused by the machine-readable instructions to perform: selecting the secured component for storing parcel to be delivered as indicated by the delivery notification. In those embodiments, the code associated with the secured component may be retrieved only when the secured component is selected.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 illustrates generally an example architecture including various components for facilitating parcel delivery to a driving apparatus in accordance with the disclosure.

FIG. 2 illustrates one example of a driving apparatus shown in FIG. 1.

FIG. 3 illustrates one example of a secured component that may be equipped to the driving apparatus shown in FIG. 2.

FIG. 4 illustrates one example of secured component shown in FIG. 3.

FIG. 5 illustrates generally a system 500 for facilitating parcel delivery to a driving apparatus in accordance with the disclosure.

FIG. 6 illustrates one example method for facilitating parcel delivery to a driving apparatus in accordance with the disclosure.

FIG. 7 illustrates another exemplary method for facilitating parcel delivery to a driving apparatus in accordance with the disclosure.

FIG. 8 illustrates another exemplary method for facilitating parcel delivery to a driving apparatus in accordance with the disclosure.

FIG. 9 illustrates a simplified computer system that can be used implement various embodiments described and illustrated herein

### DETAILED DESCRIPTION OF THE INVENTION

Embodiments can facilitate parcel delivery to a driving apparatus, while the driving apparatus is moving or idle. A third party service provider may be enabled to communicate with the driving apparatus and/or a computing device associated with a user of the driving apparatus for delivering the parcel to the driving apparatus. Such communication may include the third parcel service provider notifying the user and/or the driving apparatus that a parcel is to be delivered; and the user and/or driving apparatus transmitting location information regarding the driving apparatus for receiving the parcel delivery, availability information regarding when the parcel may be delivered to the driving apparatus, one or more instructions regarding how to deliver the parcel to the driving apparatus (e.g., deliver the parcel to a user present in the driving apparatus or store the parcel in a secured component of the driving apparatus), and/or any other information. The third party service provided may then dispatch a courier (e.g., a delivery truck) to the location of driving apparatus at a time when the driving apparatus is available for receiving the parcel.

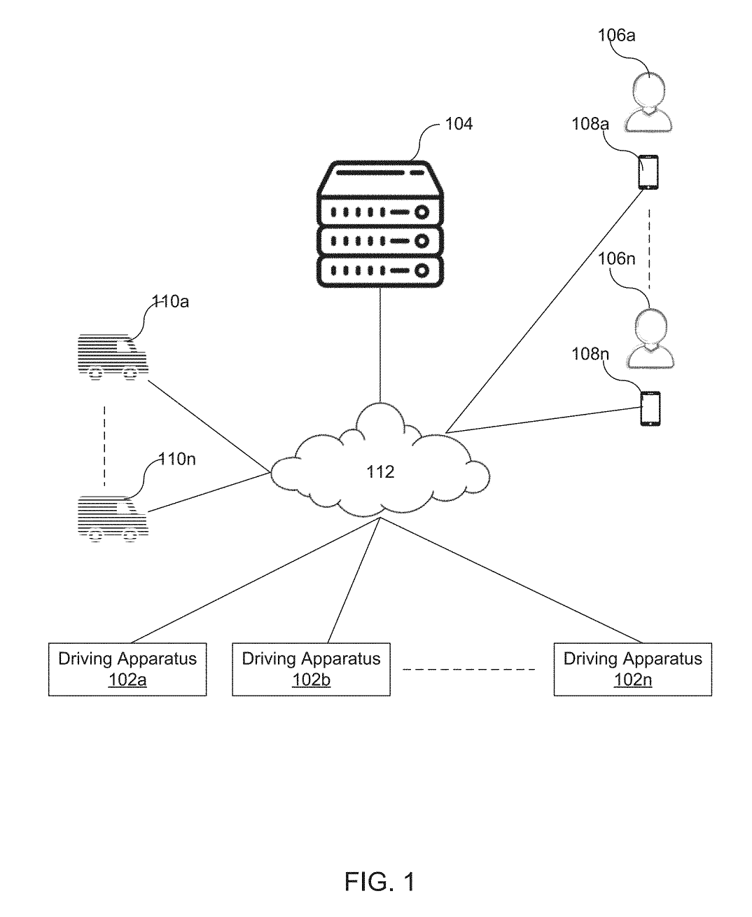

FIG. 1 illustrates generally an example architecture including various components for facilitating parcel delivery to a driving apparatus in accordance with the disclosure. Under this example architecture, driving apparatus 102a-n can be facilitated to receive a parcel devilry service provided by a third party provider such as an E-commerce website, a retailer offering goods delivery to customers, a courier such as UPS or Fedex, and/or any other type of third party service provider that may deliver parcels. As can be seen, in this example architecture, the third-party provider may have a server computer 104 that may be configured to communicate with the individual driving apparatus 102a-n via a network 112 wirelessly and/or wiredly.

A given one of driving apparatus 102a-n may include any apparatus that moves in distance. Examples of the given driving apparatus 102 may include a vehicle such as a car, a bus, a train, a truck, a tram, or any other type of vehicle; may include a vessel such as a boat, a ship, a barge, a ferry or any other type of watercraft; may include an aircraft such as an airplane, a spaceship, or any other type of aircraft; or may include any other driving apparatus. In one example, the given driving apparatus 102 is an electrical automobile.

In this example architecture, the given driving apparatus 102, such as driving apparatus 102a may be associated with one or more of users 106a-n. A given user 106 such as user 106a may be associated with one or more of computing devices 108a-n. A given computing device 108, such as computing device 108a may include a smartphone, a tablet (such as an iPad), a remote control device or unit for a driving apparatus 102 associated with the given user 106, a laptop computer, a desktop computer, or any other computing devices.

In various embodiments, the server computer 104 may be configured to communicate with the given driving apparatus 102 such as driving apparatus 102a via the network 112. It should be understood such a communication may be performed directly or indirectly between the server computer 104 and the given driving apparatus 102. For example, in some embodiments, the server computer 104 may be configured to “talk” to the given driving apparatus 102 directly without assistance from other devices. In those embodiments, the given driving apparatus may comprise one or more components configured specifically for communication with the server computer 104. However, this is not necessarily the only case. In some other embodiments, the server computer device 104 may be configured to communicate with the given driving apparatus 102 indirectly through assistance provided by one or more other devices. For example, the server computer 104 may be configured to communicate with the given driving apparatus 102 through the given computing device 106 such as the computing device 106a. As another example, there may be one or more servers in between the given driving apparatus 102 and the server computer 104 that can facilitate the communication between the two. Such server(s) is not shown in FIG. 1 as it is not the focus of this disclosure and one skilled in the art would understand such server(s) (for example a server provided by a car service company associated with the driving apparatus) can exist.

In any case, the server computer 104 may be configured to store information regarding the given driving apparatus 102, such as network ID, its current location, its availability to receive a parcel deliverer, instructions on how to access the given driving apparatus 102 for delivering the parcel and/or any other information regarding the given driving apparatus 102. The given driving apparatus 102 may be configured to report such information to the server computer 104 from time to time. The server computer 104 may be configured to transmit a delivery indication to the given driving apparatus 102 indicating that a parcel is ready to be delivered to the given driving apparatus 102.

After receiving the delivery notification from the server computer 104, the given driving apparatus 102 may send a response back to the server computer 104—the response may include information indicating an updated location of the given driving apparatus 102, its availability to receive a parcel deliverer—e.g., a time or a time period when the given driving apparatus 102 may be available for receiving the parcel delivery, instructions on how to access the given driving apparatus 102 for delivering the parcel—e.g., instructions indicating how to deliver the parcel to a user present within the given driving apparatus 102 or to a secured component on the given driving apparatus, and/or any other information.

After receiving the response from the given driving apparatus 102, the server computer 104 may be configured to schedule a delivery to the given driving apparatus 102 according to the information included in the received response. This may involve arranging a given delivery truck 110 such as delivery truck 110a or 110n as shown to deliver the parcel to the given driving apparatus 102 at the time or during a time period as indicated by the received response. In some embodiments, the server computer 104 may send scheduling message to the given driving apparatus 102 informing the given driving apparatus that the given delivery truck is or will be on the way to deliver the parcel to the given driving apparatus. In those embodiments, the given driving apparatus 102 may acknowledge the scheduling by the server computer 104 by sending a scheduling acknowledgement message back to the server computer 104.

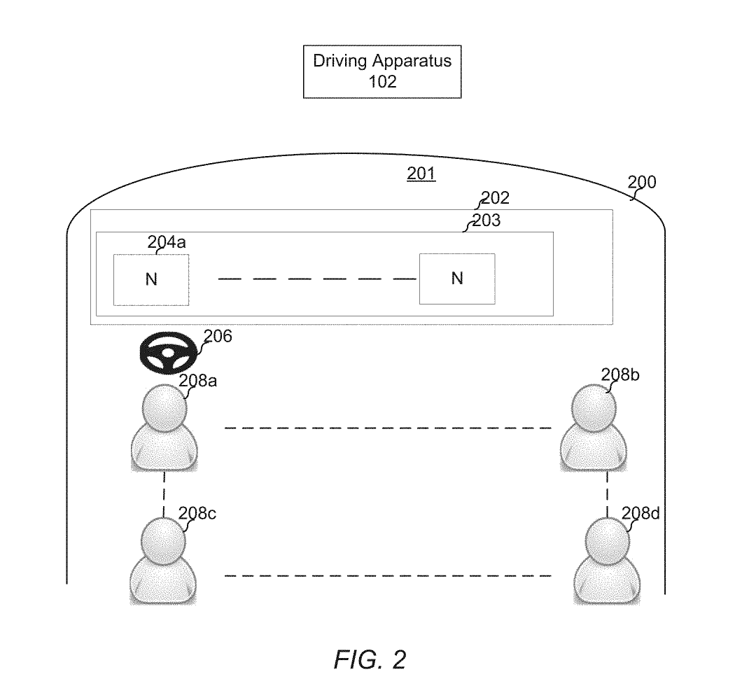

With the example architecture for facilitating parcel delivery to a driving apparatus 102 having been generally described, attention is now directed to FIG. 2, where an example of driving apparatus 200 is illustrated. The example driving apparatus 200 shown in FIG. 2 may be an possible implementation of the driving apparatus 102a-n shown in FIG. 0.1.

As shown here, the driving apparatus 200 may include a cabin 201 with a volume. In the cabin 201, there may be a dashboard 202 that has a screen 203. Although in this example, a dashboard screen 203 occupies the entire surface of the dashboard 202, this is not intended to be limiting. It is contemplated that in some cases, the dashboard screen 203 may occupy a portion of the dashboard 202 instead of the entire dashboard 202. In any case, the dashboard screen 203 is suitable to display one or more information panels, such as the information panels 204 shown in FIG. 1. In implementations, the dashboard screen 203 may include any display technology, such as liquid-crystal display (LCD), crystal LCD, light-emitting diode (LED), organic light-emitting diode (OLED), active-matrix organic light-emitting diode (AMOLED), Plasma, projection panel, cathode ray tube (CRT), and/or any other display technology. As also shown, the information panels 204 displayed on the dashboard screen 203 are separate and independent from each other such that the individual information panels 204 are displayed at corresponding positions on the dashboard screen 203. In this example, information panel 204a is displayed at position 1 on the dashboard screen 203, information panel 204b is displayed at position 2 on the dashboard screen 203, information panel 204n−1 is displayed at position N−1 on the dashboard screen 203, and information panel 204n is displayed at position N on the dashboard screen 203.

As still shown in FIG. 2, the driving apparatus 200 may comprise one or more steering wheels 206 in the cabin 201. Although only one steering wheel 206 is shown in FIG. 1, this is not intended to be limiting. In some examples, the driving apparatus 200 may include more than one steering wheel 206. For example, it is contemplated that the driving apparatus 200 may be an aircraft that comprises at least a main steering wheel 206 for the main pilot and at least a secondary steering wheel 206 for a co-pilot.

As also shown in FIG. 2, one or more users 208 may be arranged to occupy their corresponding positions in the cabin 201. The users 208 may include one or more drivers that control the movement or navigation of the driving apparatus 200, one or more passengers, and/or any other type of users 208. In this example, the user 208a is a driver that controls the driving of the driving apparatus 200, while other users 208, e.g., users 208b-d, are passengers. As still shown, there may be multiple rows of users 208 within the cabin 201 of the driving apparatus 200.

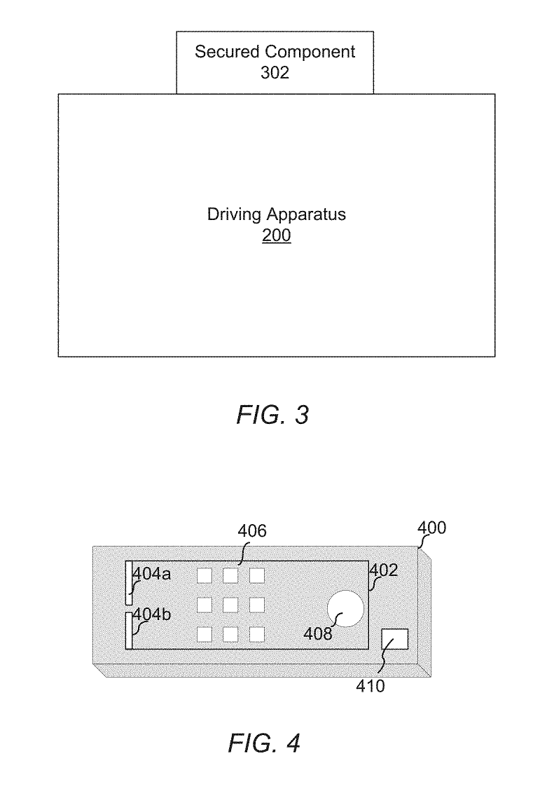

In some embodiments, for facilitating the parcel delivery, the driving apparatus 200 can be equipped with a secured component. The secured component can be used to store a parcel. A user of the driving apparatus can be enabled to access the secured component and retrieve the parcel. In some embodiments, the secured component can be unlocked and/or unlocked through one or more codes associated with the secured component. FIG. 3 illustrates one example of a secured component 302 that may be equipped to the driving apparatus 200. As shown, the secured component 302, in some embodiments, can be installed on or attached to a body of the driving apparatus 200. For example, in a case where the driving apparatus 200 is a vehicle, the secured component 302 can be installed on a front hood of the driving apparatus 200, on a side panel of the driving apparatus 200, on a trunk cover of the driving apparatus 200, and/or any other part of the driving apparatus 200. In some embodiments, the secured component 302 may be an integrated part of the driving apparatus 200. For example, in one embodiment, the secured component 302 may be a trunk of the driving apparatus 200. In another embodiment, the secured component 302 may be compartment located under a front hood of the driving apparatus 200—e.g., in a case where the driving apparatus 200 is an electrical vehicle.

FIG. 4 illustrates one example of secured component 302 shown in FIG. 3. As shown in FIG. 4, the example secured component 400 may have a cover 402 openable through one or more hinge members such as 404a and 404b, and/or the knob 408 shown. In this example, the secured component 400 has buttons 406 that can facilitate input of a passcode associated the secured component 400 for locking or unlocking the secured component 400. The secured component 400 may have a locked state, an unlocked state and/or any other state. In the locked state, the cover 402 may remain un-movable such that contents within the secured component 400 cannot be accessed. In the unlocked state, the cover 402 may become moveable such that the contents can be accessed. As mentioned above, secured component 400 can be transitioned from locked state to unlocked state through a passcode. However this is not necessarily the only case. In some embodiments, the secured component 400 may be so transitioned by one or more instructions from a remote device (e.g., from the server computer 104 and/or from a given computing device 108). In implementations, a case of the secured component 400 may be made of steel, titanium, and/or any other material(s). The secured component 400 may be designed to survive intense impact and/or pressure damage that may occur when driving apparatus 200 is involved in an accident. In some examples, the secured component 400 may comprise multiple layers such as an insulation layer and/or a thermal block layer such that the secured component 400 may resist fire or heat damages.

In some embodiments, the secured component 400 can comprise a communication component 410 configured to transmit and/or receive signals. For example, the communication component 410 can transmit a signal indicating that a parcel has been stored within the secure component 410. Such a signal may be referred to as an occupation indication. As another example, the signal transmitted by the secured component 410 can include an indication indicating the parcel has been removed from the secured component 410. The communication component 410 can be configured to transmit such signals to a remote device such as the server computer 104, the computing device(s) 108, a processor within the driving apparatus 200, and/or any other device.

In some embodiments, the driving apparatus 200 may comprise a communication component that can be configured to perform various communications described and illustrated herein with one or more remote devices, such as the server computer 104, the computing device(s) 108 associated with one or more users of the driving apparatus 200, a remote control unit for controlling the driving apparatus and/or any other remote device. As mentioned above, such communications may be performed via wireless protocol. The communication component may be configured to communicate with the remote device via one or more wireless protocols, which may include Bluetooth, laser, Infrared, MiFi, WiFi, and/or any other wireless protocol.

In some embodiments, the communication performed by the communication component of the driving apparatus 200 may include periodical transmitting updates of its current location to a remote device, such as the server computer 104, the computing device 108, and/or the delivery truck 110. For example, without limitation, the communication component can periodically (e.g., every minute) send the current location of the driving apparatus 200 at a given time to the server computer 104. In that example, the current location of the driving apparatus 200 may include coordinates obtained from a global positioning system (GPS) device within the driving apparatus 200. The server computer 104 may forward the current location information to a given delivery truck 110 dispatched to make the parcel delivery to the driving apparatus 200. In this way, the given delivery truck and/or the third party service provider can be facilitated to keep track of an updated location of the driving apparatus 200 periodically for delivering the parcel to the driving apparatus 200.

In some embodiments, the communication performed by the communication component of the driving apparatus 200 may include periodically receiving updates of the current location of a given delivery truck 110 that has been dispatched to make the parcel delivery to the driving apparatus 200 from the remote device, such as the server computer 104, the computing device 108, and/or the delivery truck 110. For example, without limitation, the communication component can periodically (e.g., every minute) receive the current location of the given delivery truck at a given time from the server computer 104. In that example, the current location of the given delivery truck 110 may include coordinates obtained from a global positioning system (GPS) device. The server computer 104 may forward the current location information regarding the given delivery truck 110 to the driving apparatus 200. In this way, the driving apparatus 200 and/or the third party service provider can be facilitated to keep track of an updated location of the given delivery truck 110 periodically when delivering the parcel to the driving apparatus 200. In some embodiments, the current location information can be used by the server computer 104 and/or the given delivery truck 110 to determine whether the driving apparatus 200 has parked, for example at a parking lot accessible to the given delivery truck 110. In this way, the parcel delivery may be made when the driving apparatus 200 is parked based on the current location of the driving apparatus 200.

In some embodiments, the driving apparatus 200 may comprise a circuit configured to store a code associated with the secured component, information regarding the driving apparatus 200, and/or any other information. For example, the driving apparatus 200 may include a data storage unit having a medium such as a hard disk or memory for storing such information. However, this is not necessarily the only case. In some examples, the driving apparatus 200 may comprise a simple circuit that can be configured to store such information, for example an 8 digit code associated with the secured component 400. In some embodiments, the code associated with the secured component 400 may include a passcode that may be used to unlock and/or lock the secured component 400. In some embodiments, the code associated with the secured component 400 may include a piece of executable instructions that can be used to unlock or lock the secured component.

The various information regarding the driving apparatus 200 may include an identification about the driving apparatus 200, for example, without limitation, a vehicle identification code associated with the driving apparatus 200. The various information may include a network ID assigned to the driving apparatus 200 such that the network ID can be used by the communication component of the driving apparatus 200 to communicate with a given remote device. For example, without limitation, such a network ID may include an IP address assigned to the driving apparatus 200 for communications with the given remote device. The various information may include location information indicating a location where the driving apparatus 200 is at a certain time point. The various information may include speed information indication a speed at which where the driving apparatus 200 is traveling at the certain time point. Other examples of the various information are contemplated.

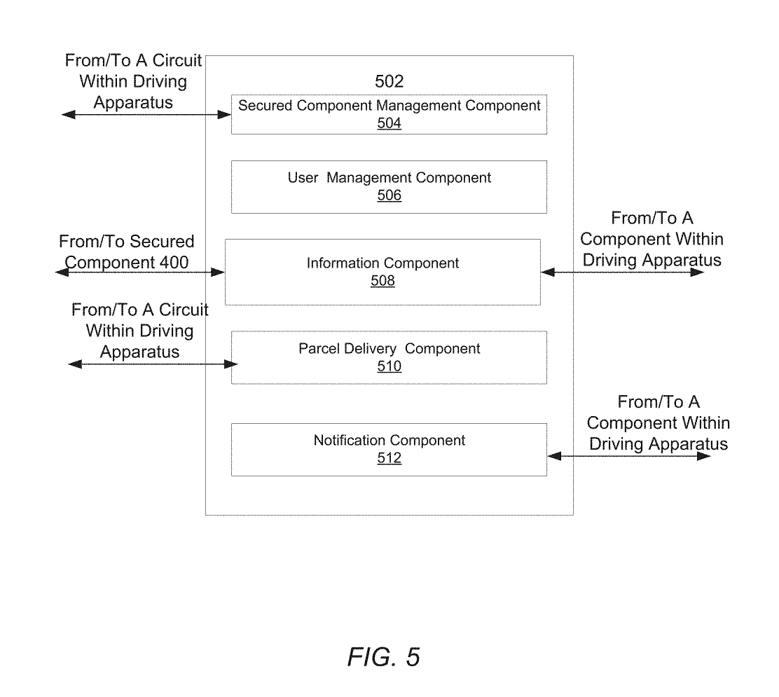

FIG. 5 illustrates generally a system 500 for facilitating parcel delivery to a driving apparatus in accordance with the disclosure. In some embodiments, the system 500 may be located within the driving apparatus 200. As shown, system 500 can include one or more of a processor 502 configured to implement computer program components, which can include a secured component management component 504, a user management component 506, an information component 508, a parcel delivery component 510, a notification component 512, and/or any other components.

The secured component management component 504 can be configured to manage one or more of a secured component, such as secured component 400 shown in FIG. 4, for the driving apparatus 200. In some embodiments, the driving apparatus 200 may comprise more than one secured component. An individual secured component may be associated with an identification identifying the secured component, such as a two digit number. In some embodiments, the individual secured component may be associated with a code that can be used to lock and/or unlock the secured component. Management of the individual secured component by the secured component management component 504 may include keeping track of state information regarding the individual secured component. For example, a table may be managed by the secured component management component 504, where the table records an association between the individual secured component and a current status of the secured component. The current status may include indications about a lock/unlock state of the secured component and/or its contents. For example, without limitation, the current status of the secured component may include the following: locked without any content, locked with content, unlocked with content, unlocked without any content, and/or any other status.

In some embodiments, based on the aforementioned statuses of the individual secured component(s), secured component management component 504 can determine whether a particular secured component is available for storing a parcel to be delivered to the driving apparatus 200. This may involve consulting the table mentioned above and retrieve the current status of the secured component(s), consulting the information component 508 to determine whether another delivery was already scheduled to use that secured component, and/or any other operations.

The user management component 506 can be configured to manage one or more users of the driving apparatus 200, such as one or more of user 106a-n shown in FIG. 1. This may involve obtaining and/or storing user information regarding the user(s) of the driving apparatus 200. The user information regarding a given one of the user(s) of the driving apparatus 200 may include an identification about the user—e.g., the user's name, age, contact information (phone number(s), email address(es)) regarding the user, residence information about the user—e.g., a physical address where the user lives, information regarding one or more credit cards or bank accounts associated with the user, and/or any other user information. In some embodiments, the user management component 506 may be configured to receive information that can be used to identify the user from a device located within the driving apparatus 200, such as an image sensor, a fingerprint reader, a microphone, and/or any other device. For example, in those embodiments, the user management component 506 can receive an image from a camera located within the driving apparatus 200 and determine that a person is present in the driving apparatus 200. In that example, the user management component 506 may then consult with a table recording information regarding known user(s) of the driving apparatus 200 to determine whether that person in the image is a known user of the driving apparatus 200.

The information component 508 can be configured to obtain, transmit, and/or manage various information regarding the driving apparatus. Such information may include a delivery indication indicating that parcel is to be delivered to the driving apparatus 200. In some embodiments, the delivery indication may include information indicating contents of the parcel, one or more intended recipients for the parcel, sender(s) of the parcel, and/or any other information pertaining to parcel delivery. Such a delivery indication can be received from a remote device such as the server computer 104 or a computing device 108 associated with a user of the driving apparatus 200. Such information may include location information indicating a current location of the driving apparatus. For example, the information component 508 can be configured to generate such location information about the driving apparatus 200 from time to time and transmit the location information to the remote device from time to time to report the location(s) of the driving apparatus 200 over time.

The information managed, obtained and/or transmitted by the information component 508 may include a request received from the remote device indicating a request for delivering a parcel to the driving apparatus 200. In some embodiments, after receiving such a request, the information component 508 can be configured to generate a response to the request. The response may include the location information regarding the driving apparatus 200, availability information indicating when the driving apparatus 200 may be available for receiving the delivery, whether one or more recipients as indicated in the parcel delivery indication are present in the driving apparatus 200, and/or any other information that may assist the third party service provider to deliver the parcel to the driving apparatus 200. In one example, the information component 508 may transmit the response including the current location information regarding the driving apparatus 200 to the remote device from time to time until the parcel has been delivered. This may be useful when the driving apparatus 200 is moving when the delivery indication is received and does not stop moving until sometime before the parcel is delivered to the driving apparatus 200.

In some embodiments, the information managed, obtained and/or transmitted by the information component 508 may include a request received from the remote device for locking or unlocking a secured component. For example, the server computer 104 may send such a request to the driving apparatus 200 for obtaining a passcode associated with the secured component to unlock the secured component when the parcel is delivered to the driving apparatus 200.

In implementations, the information component 508 may obtain and/or transmit some or all of the information mentioned above to the remote device via the communication component of driving apparatus 200 described and illustrated herein. For example, the system 500 may receive the delivery indication from the server computer 104 through the communication component of the driving apparatus 200, and generate a response to the delivery indication. The response may be transmitted by the system 500 to the server computer 104 for acknowledging and/or scheduling the parcel delivery to the driving apparatus 200.

As also shown, the information component 508 may be configured to communicate with the secured component, for example via the communication component 410 of the secured component 400 as shown in FIG. 4 and described herein. Such communication may include inquiring a status about a given secured component or given secured components. For example, when there are more than one secured component in the driving apparatus 200, the information component 508 may communicate with each of the secured components to determine their current statuses—for example whether they are locked with contents or locked without contents. In that example, such a determination can assist parcel delivery component 510 to select a secured component that is available for receiving the parcel delivery.

In some embodiments, the information component 508 may be configured to obtain various information regarding the driving apparatus 200's availability to receive the parcel delivery. For example, such information may include a traveling schedule of the driving apparatus 200 (e.g., different routes the driving apparatus 200 will travel on at different times), a location schedule of the driving apparatus 200 (e.g., different locations the driving apparatus 200 will be at different times), a parking schedules of the driving apparatus 200 (e.g., different parking spots driving apparatus 200 will be at different times). Such information can be transmitted to the remote device such as the server computer 104 to enable the third party service to deliver the parcel at a location that may be suitable for the driving apparatus 200 to receive the parcel. For example, without limitation, the third service provider may process such information to determine a location at a time where the driving apparatus 200 will be available to receive the parcel and where a delivery truck 110 is close by deliver or on the way to other delivery locations.

The parcel delivery component 510 may be configured to retrieve a code associated with the secured component for facilitating unlocking of the secured component. This may involve receiving an identification for the secured component, for example from the information component 508, and retrieving the code associated with the secured component based in the identification for the secured component. As mentioned above, in some embodiments, an individual secured component may be openable (unlocked) through a passcode associated with the secured component. In those embodiments, after the request for retrieving the passcode is received by system 500 (for example via the information component 508 as described above), the parcel delivery component 510 may be instructed to retrieve the passcode so that the information component 508 can include it in a response to the request for transmission to the remote device.

However, it should be understood the passcode is not the only way for opening or unlocking the secured component in accordance with the disclosure. In some embodiments, the secured component may be unlocked automatically (without human intervention) through a piece of executable code. In those embodiments, the parcel delivery component 510 may be configured to obtain such a code so that the information component 508 can include such a code in the response back to the server computer 104. In those embodiments, the server computer 104 may be enabled to remotely open the secured component with such code later when the parcel is delivered to the driving apparatus 200, for example by the delivery truck 110 shown in FIG. 1.

In some embodiments, the parcel delivery component 510 can be configured to generate the code for the secured component from time to time. For example, the parcel delivery component 510 may be configured to generate a code for unlocking/locking the secured component such the passcode is only valid for a preset time period (for example for 24 hours) or after the parcel is delivered to the driving apparatus 200. As another example, without limitation, the parcel delivery component 510 may be configured to generate the code at a request of a user of the driving apparatus 200. For example, the user may be enabled to request a current code to be changed for locking or unlocking the secured component.

The parcel delivery component 510 can be configured to facilitate unlocking the secured component through the code associated with the secured component. In some embodiments, this may involve receiving an unlock instruction to unlock the secured component, for example through the communication component of the driving apparatus 200. For example, as mentioned above, the server computer 104 may send an instruction to driving apparatus 200 when the delivery truck has arrived at the location of the driving apparatus 200 to open a particular secured component associated with one or more recipients of the driving apparatus 200. In that example, after such an instruction is received, the parcel delivery component 510 may be configured to open that particular secured component. This may involve implementing the instruction to unlock the particular secured component using the code associated with that particular secured component.

The notification component 512 may be configured to generate a notification for transmission to the remote device. The notification generated by the notification component 512 may include a delivery confirmation indicating that a parcel has been successfully placed in the secured component. Such a delivery confirmation can be generated by the notification component 512 when the delivery indication for a parcel is received from the remote device and as well as an occupation indication of the parcel that is a subject of the delivery indication has been received from the secured component 400 via the communication component 410. Such a notification can be transmitted to a computing device 108 associated with a user 106 of the driving apparatus 200.

The notification generated by the notification component 512 may include a notification to the server computer 104 indicating that the parcel has been delivered to the driving apparatus 200 and has been retrieved by at least one intended recipient of the parcel. Such a notification can be generated by the notification component 512 when the delivery indication for a parcel is received from the remote device and as well as an removal indication of the parcel that is a subject of the delivery indication has been received from the secured component 400 via the communication component 410.

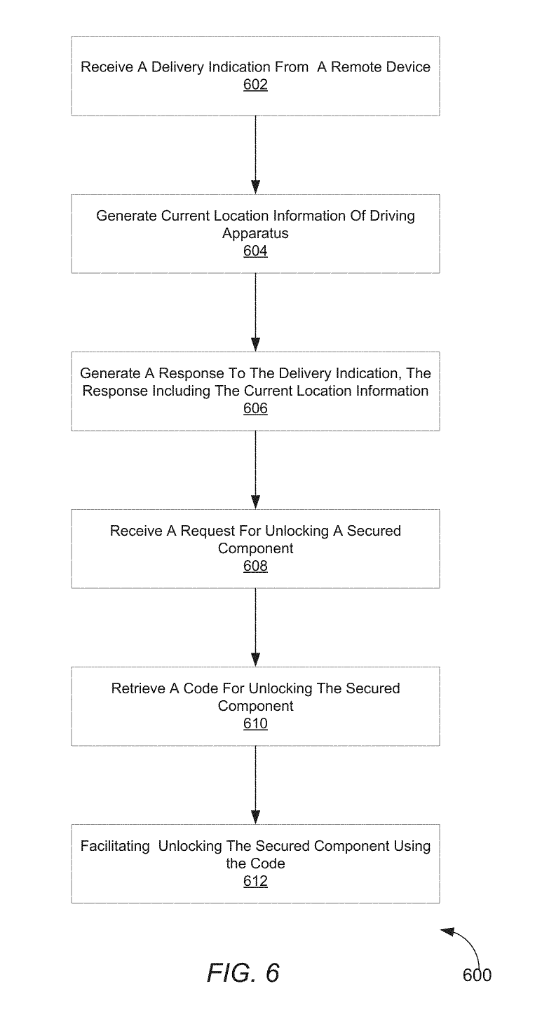

With examples of various components that may be included a system for facilitating parcel delivery to a driving apparatus having been generally described, attention is now directed to FIGS. 6-8 where various methods that can enable such a system to facilitate parcel delivery are illustrated and described.

FIG. 6 illustrates one example method for facilitating parcel delivery to a driving apparatus in accordance with the disclosure. The method presented in FIG. 6 and described below is intended to be illustrative and non-limiting. The particular series of processing steps depicted in FIG. 6 is not intended to be limiting. It is appreciated that the processing steps may be performed in an order different from that depicted in FIG. 6 and that not all the steps depicted in FIG. 6 need be performed. In certain implementations, the method 600 may be implemented by a computer system, such as the system 500 shown in FIG. 5.

In some embodiments, the method depicted in method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At 602, a delivery indication may be received. As described and illustrated herein, the delivery indication may indicate that a parcel is to be delivered to the driving apparatus by virtue of one or more recipients of the parcel are also user(s) of the driving apparatus. The delivery indication may include information indicating identities of the recipient(s) of the parcel (e.g., name, contact information, residence information), contents of the parcel, sender of the parcel, and/or any other information pertaining to the parcel delivery. In some implementations, operations involved 602 may be implemented by an information component the same as or substantially similar to information component 508 described and illustrated herein.

At 604, current location information of the driving apparatus can be generated. It should be understood operation 604 may be performed before or after operation 602. In some embodiments, the performance of operation 604 does not necessarily depend on whether the delivery indication is received 602. For example, the current location of driving apparatus can be obtained from time to time (e.g., periodically) at 604. Of course, in some other embodiments, the current location information about the driving apparatus may be generated after the delivery indication is received at 602. In some implementations, operations involved 604 may be implemented by an information component the same as or substantially similar to information component 508 described and illustrated herein.

At 606, a response to the delivery indication can be generated. In some embodiments, the response may include the current location information generated at 604. In some embodiments, the response generated at 606 may include other information such as whether at least one recipient of the parcel as indicated in the delivery indication is present in the driving apparatus, whether the driving apparatus is at all associated with at least one recipient of the parcel, a future time period and a future location of the driving apparatus when and where the driving apparatus will be available to receive the parcel delivery (e.g., the driving apparatus will be parked at a specification from 3 pm to 5 pm today), one or more secured components that may be available for the parcel delivery when no recipient is present in the driving apparatus, and/or any other information pertaining facilitate the delivery of the parcel to the driving apparatus. In some embodiments, such a response may be generated and transmitted to a remote device (e.g., server computer 104) from time to time until a delivery confirmation is received. In some implementations, operations involved 606 may be implemented by an information component the same as or substantially similar to information component 508 described and illustrated herein.

At 608, a request for unlocking a secured component may be received. As mentioned above, in certain situation, the recipient(s) of the parcel may not be present in the driving apparatus at the time when the delivery is scheduled. In that situation, the parcel may be delivered to the secured component described and illustrated herein. As also described and illustrated herein, the secured component may be associated with a code, such as a passcode that can be used to unlock and/or lock the secured component. At 608, such a code may be requested by a remote device such as the server computer 104 after the response generated at 606 is received by the server computer 104. In some implementations, operations involved 608 may be implemented by an information component the same as or substantially similar to information component 508 described and illustrated herein.

At 610, the code requested at 608 may be retrieved. As mentioned above, in some embodiments, the driving apparatus may have more than one secured component. For example, as illustration, the driving apparatus may comprise 4 secured components for 4 different users of the driving apparatus. At 610, after the code request is received, a specific code for the secured component as indicated in the code request can be retrieved. In some implementations, operations involved 610 may be implemented by parcel delivery component the same as or substantially similar to parcel delivery component 510 described and illustrated herein.

At 612, the unlocking of the secured component can be facilitated using the code retrieved at 610. As mentioned above, in some embodiments, this may simply involve transmitting the code to a remote device such as server computer 104 so that the code can be distributed to a deliver person. The delivery person can use the code to unlock the secured component when he/she has arrived at the driving apparatus for the parcel delivery. However, this is not necessarily the only case. As also mentioned above, in some embodiments, the secured component can be unlocked remotely for example by the server computer 104 after the delivery person has arrived. In those embodiments, operations at 612 may involve receiving the unlocking instruction from the remote device, implementing the unlocking instruction by executing the code, and/or any other operations. In some implementations, operations involved 612 may be implemented by parcel delivery component the same as or substantially similar to parcel delivery component 510 described and illustrated herein.

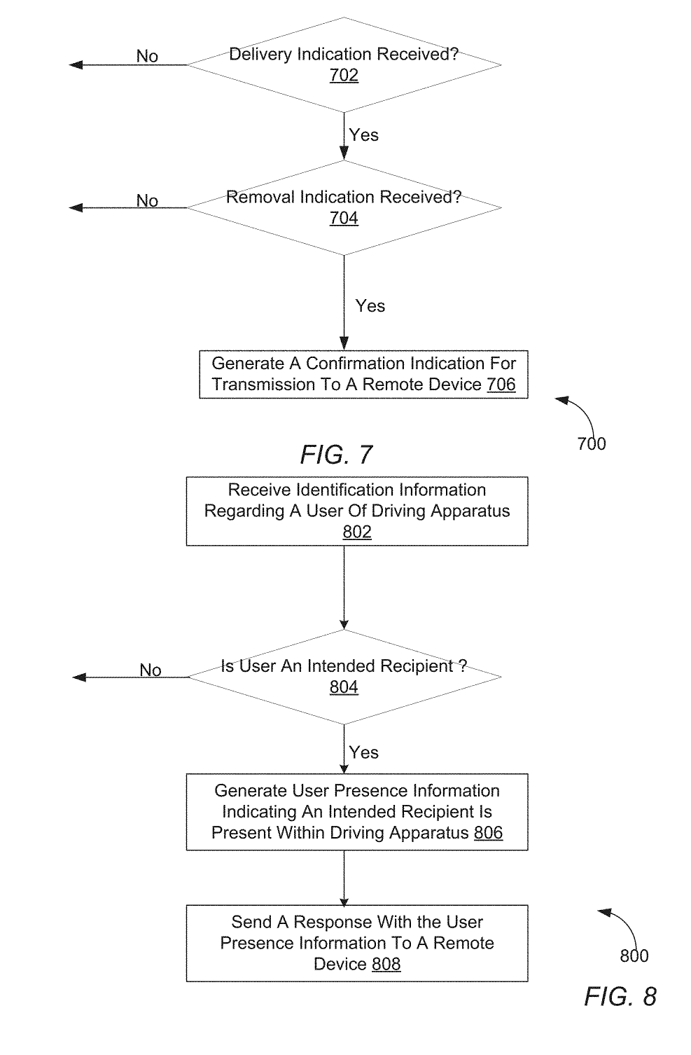

FIG. 7 illustrates another exemplary method for facilitating parcel delivery to a driving apparatus in accordance with the disclosure. The method presented in FIG. 7 and described below is intended to be illustrative and non-limiting. The particular series of processing steps depicted in FIG. 7 is not intended to be limiting. It is appreciated that the processing steps may be performed in an order different from that depicted in FIG. 7 and that not all the steps depicted in FIG. 7 need be performed. In certain implementations, the method 700 may be implemented by a computer system, such as the computer system 100 shown in FIG. 1.

In some embodiments, the method depicted in method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

At 702, a determination is made with respect to whether a delivery indication as described and illustrated herein has been received. As can be seen, when it is determined that the delivery indication has been received, the process proceeds to 704; and otherwise the process proceeds to some other steps. In some implementations, operations involved 702 may be implemented by parcel delivery component the same as or substantially similar to parcel delivery component 510 described and illustrated herein.

At 704, a determination whether a removal indication as illustrated and described herein is received is made. Such a removal indication may be generated and transmitted by the communication component 410 of the secured component shown in FIG. 4. As can be seen, when it is determined that the removal indication has been received, the process proceeds to 706; and otherwise the process proceeds to some other steps. In some implementations, operations involved 704 may be implemented by parcel delivery component the same as or substantially similar to parcel delivery component 510 described and illustrated herein.

At 706, a confirmation indication is generated for indicating that the parcel has been delivered to the driving apparatus and has been removed. Such a confirmation indication may be transmitted to the remote device such as the server computer 104 and the computing device 108 associated with the user 106 of the driving apparatus. In some implementations, operations involved 706 may be implemented by parcel delivery component the same as or substantially similar to parcel delivery component 510 described and illustrated herein.

FIG. 8 illustrates another exemplary method for facilitating parcel delivery to a driving apparatus in accordance with the disclosure. The method presented in FIG. 8 and described below is intended to be illustrative and non-limiting. The particular series of processing steps depicted in FIG. 8 is not intended to be limiting. It is appreciated that the processing steps may be performed in an order different from that depicted in FIG. 8 and that not all the steps depicted in FIG. 8 need be performed. In certain implementations, the method 800 may be implemented by a computer system, such as the computer system 100 shown in FIG. 1.

In some embodiments, the method depicted in method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

At 802, identification information regarding a user of driving apparatus is received. As described and illustrated herein, such identification information may include an image of the user captured by a camera sensor located within the driving apparatus, a fingerprint provided by the user through a finger print reader located within the driving apparatus and/or any other type of identification information. In some implementations, operations involved 802 may be implemented by information component the same as or substantially similar to information component 508 described and illustrated herein.

At 804, a determination whether the user is an intended recipient as indicated in a delivery indication is made. Such determination may involve obtaining user information regarding the user based on the identification information received at 802, comparing the user information with the information for the recipient(s) in the delivery indication, and/or any other operations. As can be seen, when it is determined that the user is an intended recipient, the process proceeds to 806; and otherwise the process proceeds to some other steps. In some implementations, operations involved 804 may be implemented by information component the same as or substantially similar to information component 508 described and illustrated herein.

At 806, user presence information can be generated to indicate at least one recipient of the parcel is present in the driving apparatus. In some implementations, operations involved 806 may be implemented by parcel delivery component the same as or substantially similar to parcel delivery component 510 described and illustrated herein.

At 810, the user presence information generated at 806 can be included in a response for transmission to a remote device such as server computer 104. For example, the user presence information can be transmitted to the server computer 104 so that the parcel may be delivered to the identified user present in the driving apparatus instead of to the secured component of the driving apparatus. In some examples, the user presence information may include contact information regarding the identified the user present in the driving apparatus, such as a mobile phone number. Such contact information can enable the third service to make a contact with the identified user when the delivery truck is about to make the delivery to the identified user when it is near the driving apparatus. In some implementations, operations involved 810 may be implemented by parcel delivery component the same as or substantially similar to parcel delivery component 510 described and illustrated herein.

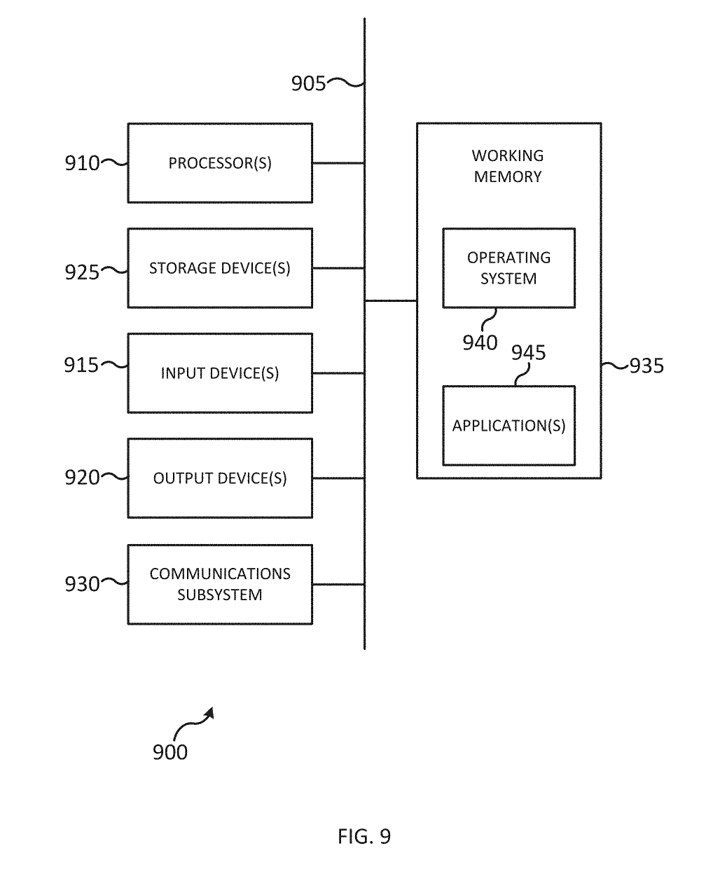

FIG. 9 illustrates a simplified computer system that can be used implement various embodiments described and illustrated herein. A computer system 900 as illustrated in FIG. 9 may be incorporated into devices such as a portable electronic device, mobile phone, or other device as described herein. FIG. 9 provides a schematic illustration of one embodiment of a computer system 900 that can perform some or all of the steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 600 is shown comprising hardware elements that can be electrically coupled via a bus 606, or may otherwise be in communication, as appropriate. The hardware elements may include one or more processors 610, including without limitation one or more general-purpose processors and/or one or more special-purpose processors such as digital signal processing chips, graphics acceleration processors, and/or the like; one or more input devices 619, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 629, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset such as a Bluetooth™ device, an 602.11 device, a WiFi device, a WiMax device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g. the first electronic device, may be incorporated into the computer system 600, e.g., an electronic device as an input device 619. In some embodiments, the computer system 600 will further comprise a working memory 639, which can include a RAM or ROM device, as described above.

The computer system 600 also can include software elements, shown as being currently located within the working memory 639, including an operating system 640, device drivers, executable libraries, and/or other code, such as one or more application programs 649, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 629 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the procedures of such methods are performed by the computer system 600 in response to processor 610 executing one or more sequences of one or more instructions, which might be incorporated into the operating system 640 and/or other code, such as an application program 649, contained in the working memory 639. Such instructions may be read into the working memory 639 from another computer-readable medium, such as one or more of the storage device(s) 629. Merely by way of example, execution of the sequences of instructions contained in the working memory 639 might cause the processor(s) 610 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 626. Volatile media include, without limitation, dynamic memory, such as the working memory 636.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 609 then might carry the signals and/or the data, instructions, etc. carried by the signals to the working memory 639, from which the processor(s) 610 retrieves and executes the instructions. The instructions received by the working memory 639 may optionally be stored on a non-transitory storage device 629 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

1. A system within a driving apparatus, the system comprising:
a secured component openable through a cover member hinged to the secured component, the secured component having a locked state and an unlocked state;
a communication component configured to communicate with a remote device;
a circuit configured to store a code associated with the secured component; and
a processor configured to execute machine-readable instructions such that when the machine-readable instructions are executed, the processor is caused by the execution of the machine-readable instructions to perform:
receiving a delivery indication that a parcel is to be delivered to the driving apparatus;
generating current location information indicating a current location of the driving apparatus;
generating, for transmission to the remote device, a response including the current location information;
receiving a request, from the remote device, for unlocking the secured component;
in response to the request received from the remote device, retrieving the code associated with the secured component from the circuit; and
unlocking, automatically, the secured component through the code associated with the secured component without requiring a user to input any code.

2. The system of claim 1, wherein the secured component further comprises a communication unit configured to communicate with the processor, the communication unit being configured to:
transmit an occupation indication to the processor indicating the secured component is occupied with a parcel; and
transmit a removal indication to the processor indicating the secured component the parcel has been removed from the secured component.

3. The system of claim 2, wherein the processor is further caused by the execution of the machine-readable instructions to perform:
determining if the delivery indication is received;
determining if the occupation indication is received from secured component; and
when the occupation indication and the delivery indication are determined to have been both received, generating a confirmation indication for transmission to a computing device associated with a user of the driving apparatus.

4. The system of claim 2, wherein the current location information and the response are periodically generated until the occupation indication is received from the secured component.

5. The system of claim 1, wherein the processor is further caused by the execution of the machine-readable instructions to perform:
generating, for association with the secured component, the code, wherein the code is valid for a preset time period such that the code is usable to unlock the secured component during the preset time period; and
storing the code on the circuit.

6. The system of claim 1, wherein the code associated with the secured component is further associated with a user of the driving apparatus.

7. The system of claim 1, wherein the delivery indication includes information indicating an intended recipient of the parcel, and processor is further caused by the machine-readable instructions to perform:
receiving identification information regarding a user of the driving apparatus, the user being within the driving apparatus;
determining whether the user of the driving apparatus is the intended recipient of the parcel; and
when it is determined that the user is the intended recipient of the parcel, generating presence information indicating the intended recipient is within the driving apparatus; and, wherein the response further includes the presence information.

8. The system of claim 1, wherein the processor is further caused by the machine-readable instructions to perform:
receiving, over a network, an unlock instruction to unlock the secured component; and, wherein
facilitating unlocking the secured component through the code associated with the secured component comprises implementing the unlocking instruction using the code.

9. The system of claim 1, wherein the processor is further caused by the machine-readable instructions to perform:
transmitting, over a network, the code associated with secured component for unlocking the secured component.

10. The system of claim 1, wherein the processor is further caused by the machine-readable instructions to perform:
determining if the secured component is occupied; and
selecting the secured component for storing parcel to be delivered as indicated by the delivery notification; and, wherein
the code associated with the secured component is retrieved only when the secured component is selected.
